(19) United States
(12) Patent Application Publication
(10) Pub. No.: US 2023/0177466 A1
(43) Pub. Date: Jun. 8, 2023

(54) SYSTEMS AND METHODS RANKING REQUISITIONS BASED ON MULTI-STAGE MACHINE LEARNING

(71) Applicant: Meta Platforms, Inc., Menlo Park, CA (US)

(72) Inventor: Miaoqing Fang, Menlo Park, CA (US)

(21) Appl. No.: 16/588,694

(22) Filed: Sep. 30, 2019

(51) Int. Cl. G06Q 10/10; G06F 16/2457; G06F 16/248

(52) U.S. Cl. CPC G06Q 10/1053; G06F 16/24578; G06F 16/248

(57) ABSTRACT

Systems, methods, and non-transitory computer-readable media can be configured to determine one or more requisition clusters associated with a candidate, wherein the requisition clusters are associated with one or more requisitions. A requisition score associated with the one or more requisitions associated with the one or more requisition clusters can be determined based in part on the candidate. One or more requisition recommendations can be provided based in part on the requisition score.

### FIELD OF THE INVENTION

The present technology relates to the field of machine learning. More particularly, the present technology relates to techniques for ranking requisitions (e.g., job requisitions) for candidates based on multi-stage machine learning models.

### BACKGROUND

Today, people often utilize computing devices (or systems) for a wide variety of purposes. For example, an organization can publish a job requisition seeking candidates for an available position at the organization. Potential candidates can respond to the job requisition by providing information about their qualifications or credentials, for example, by submitting resumes. In some cases, an organization can publish large volumes of job requisitions and receive large volumes of resumes for the job requisitions. The large volumes of job requisitions published and the large volumes of resumes received can create challenges with regard to assessing the large volumes of resumes and identifying suitable job candidates.

### SUMMARY

Various embodiments of the present technology can include systems, methods, and non-transitory computer readable media configured to determine one or more requisition clusters associated with a candidate, wherein the requisition clusters are associated with one or more requisitions. A requisition score associated with the one or more requisitions associated with the one or more requisition clusters can be determined based in part on the candidate. One or more requisition recommendations can be provided based in part on the requisition score.

In some embodiments, one or more requisition embeddings can be generated for the one or more requisitions. A candidate embedding can be generated based in part on the candidate.

In some embodiments, generating the one or more requisition embeddings can be based in part on candidate features of candidates associated with the one or more requisitions.

In some embodiments, determining the one or more requisition clusters can comprise determining one or more requisition cluster scores for the one or more requisition clusters based in part on the candidate embedding. The one or more requisition clusters can be ranked based in part on the one or more requisition cluster scores.

In some embodiments, the one or more requisition clusters are generated based in part on the one or more requisition embeddings, wherein the one or more requisition embeddings associated with the one or more requisition clusters are within a threshold proximity to each other.

In some embodiments, the one or more requisition embeddings and the one or more candidate embeddings are generated based in part on one or more machine learning models.

In some embodiments, providing the one or more requisition recommendations can comprise ranking the one or more requisitions associated with the one or more requisition clusters based in part on the requisition scores.

In some embodiments, requisitions that have been inactive for a threshold period of time are excluded from the ranking.

In some embodiments, requisitions that have been fulfilled are excluded from the ranking.

In some embodiments, determining the one or more requisition clusters and determining the requisition score are based in part on one or more machine learning models.

It should be appreciated that many other features, applications, embodiments, and/or variations of the present technology will be apparent from the accompanying drawings and from the following detailed description. Additional and/or alternative implementations of the structures, systems, non-transitory computer readable media, and methods described herein can be employed without departing from the principles of the present technology.

### BRIEF DESCRIPTION OF THE DRAWINGS

FIG. 1 illustrates an example system including an example requisition recommendation module, according to an embodiment of the present technology.

FIG. 2 illustrates an example embedding module, according to an embodiment of the present technology.

FIG. 3A illustrates an example requisition cluster module, according to an embodiment of the present technology.

FIG. 3B illustrates an example requisition ranking module, according to an embodiment of the present technology.

FIG. 4 illustrates an example functional block diagram, according to an embodiment of the present technology.

FIG. 5 illustrates an example process for generating a set of requisition recommendations, according to an embodiment of the present technology.

FIG. 6 illustrates a network diagram of an example system including an example social networking system that can be utilized in various scenarios, according to an embodiment of the present technology.

FIG. 7 illustrates an example of a computer system or computing device that can be utilized in various scenarios, according to an embodiment of the present technology.

The figures depict various embodiments of the present technology for purposes of illustration only, wherein the figures use like reference numerals to identify like elements. One skilled in the art will readily recognize from the following discussion that alternative embodiments of the structures and methods illustrated in the figures can be employed without departing from the principles of the present technology described herein.

### DETAILED DESCRIPTION

### Approaches for Secure Authentication

Today, people often utilize computing devices (or systems) for a wide variety of purposes. For example, an organization can publish a job requisition seeking candidates for an available position at the organization. Potential candidates can respond to the job requisition by providing information about their qualifications or credentials, for example, by submitting resumes. In some cases, an organization can publish large volumes of job requisitions and receive large volumes of resumes for the job requisitions. The large volumes of job requisitions published and the large volumes of resumes received can create challenges with regard to assessing the large volumes of resumes and identifying suitable job candidates.

Under conventional approaches, organizations utilize requisitions to find suitable candidates for unfilled job positions at the organization. Organizations can utilize, for example, a platform to publish their requisitions. Such requisitions may describe various requirements of the unfilled job positions and may describe certain qualifications that suitable candidates should have. Potential candidates can respond to requisitions by providing information through the platform. In some cases, potential candidates can respond to requisitions by providing resumes that describe their experience and qualifications. Organizations can hire recruiters that sift through or perform electronic searches (e.g., keyword searches) on the resumes one at a time to find a suitable candidate for a given job position. However, under conventional approaches, sifting through or searching on resumes one at a time can present significant challenges. For example, a large organization may have a large number of unfilled job positions and, accordingly, publish a large volume of requisitions to fill the large number of unfilled job positions. The large volume of requisitions may attract a large number of candidates who provide a large volume of resumes. Sifting through or searching on the large volume of resumes can present significant challenges in terms of efficiency and scalability. Further, in some cases, candidates may provide resumes for some requisitions for which they feel they are qualified candidates but fail to provide resumes for other requisitions for which they may also be qualified. Candidates failing to provide resumes for all requisitions for which they are qualified can present significant challenges in terms of efficacy. These challenges of efficiency, scalability, and efficacy become exacerbated as volumes of requisitions and volumes of candidate resumes increase. Thus, conventional approaches, such as those described, are not effective in addressing these and other problems arising in computer technology.

An improved approach rooted in computer technology overcomes the foregoing and other disadvantages associated with conventional approaches specifically arising in the realm of computer technology. In various embodiments, the present technology provides for generating requisition recommendations for candidates. The requisition recommendations can be generated using multi-stage machine learning methodologies. In some embodiments, the present technology can generate, using trained machine learning models, candidate embeddings for candidates and requisition embeddings for requisitions. Candidate embeddings can be numerical representations (e.g., vectors) of candidates, and requisition embeddings can be numerical representations (e.g., vectors) of requisitions. Requisition embeddings can be mapped in a vector space, and clusters of requisition embeddings can be generated based on, for example, a nearest neighbor algorithm. In some embodiments, the present technology can determine requisition cluster scores for requisition clusters based on a candidate embedding of a candidate using a trained machine learning model. The requisition cluster scores can indicate an affinity between the requisition clusters and the candidate embedding. Based on the requisition cluster scores, the requisition clusters can be ranked for the candidate embedding. Higher ranked requisition clusters can be more likely to contain requisition embeddings corresponding to requisitions for which the candidate is likely to be qualified than lower ranked requisition clusters. In some embodiments, the present technology can determine requisition scores of requisition embeddings in a requisition cluster based on a candidate embedding of a candidate using a trained machine learning model. The requisition scores can indicate an affinity between the requisition embeddings and the candidate embedding. Based on the requisition scores, requisitions corresponding to the requisition embeddings can be ranked for the candidate corresponding to the candidate embedding. Higher ranked requisitions can be requisitions for which the candidate is more likely to be qualified than lower ranked requisitions. For example, an organization may be considering a potential candidate for a large volume of requisitions. A candidate embedding can be generated for the potential candidate, and requisition embeddings can be generated for each requisition. The requisition embeddings can be clustered into requisition clusters. Requisition cluster scores can be generated for each requisition cluster. The requisition clusters can be ranked based on the requisition cluster scores. Requisition scores can be generated for requisition embeddings in the highest ranked requisition clusters. The requisition embeddings in the highest ranked requisition clusters can be ranked based on the requisition scores. The highest ranked requisition embeddings in the highest ranked requisition clusters can correspond with requisitions for which the potential candidate is likely to be qualified and can be provided as requisition recommendations. Additional details relating to the present technology are provided below.

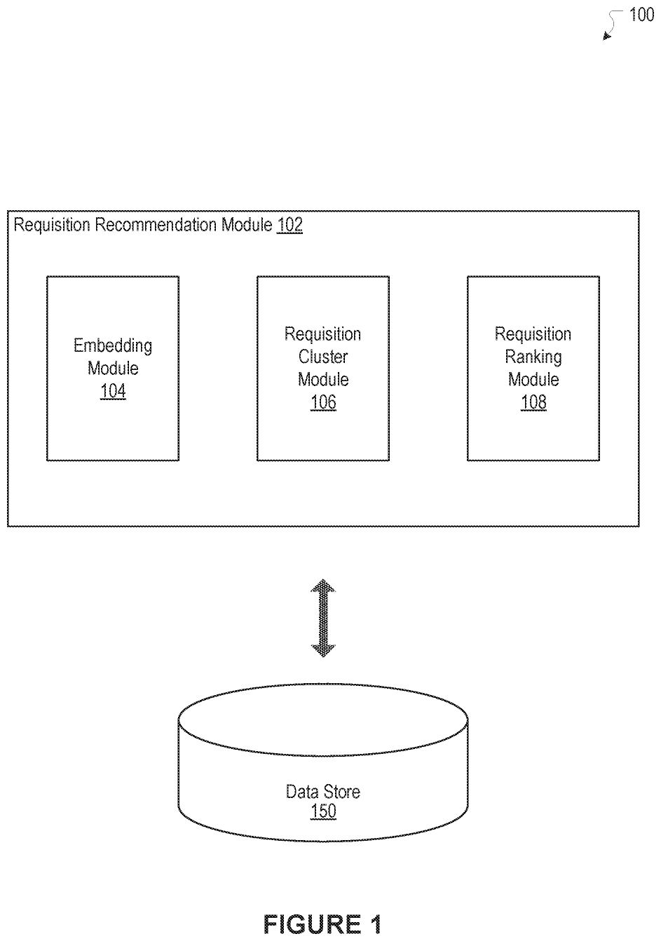

FIG. 1 illustrates an example system 100 including an example requisition recommendation module 102, according to an embodiment of the present technology. As shown in the example of FIG. 1, the requisition recommendation module 102 can include an embedding module 104, a requisition cluster module 106, and a requisition ranking module 108. In some embodiments, the example system 100 can include one or more data store(s) 150. The components (e.g., modules, elements, etc.) shown in this figure and all figures herein are exemplary only, and other implementations may include additional, fewer, integrated, or different components. Some components may not be shown so as not to obscure relevant details.

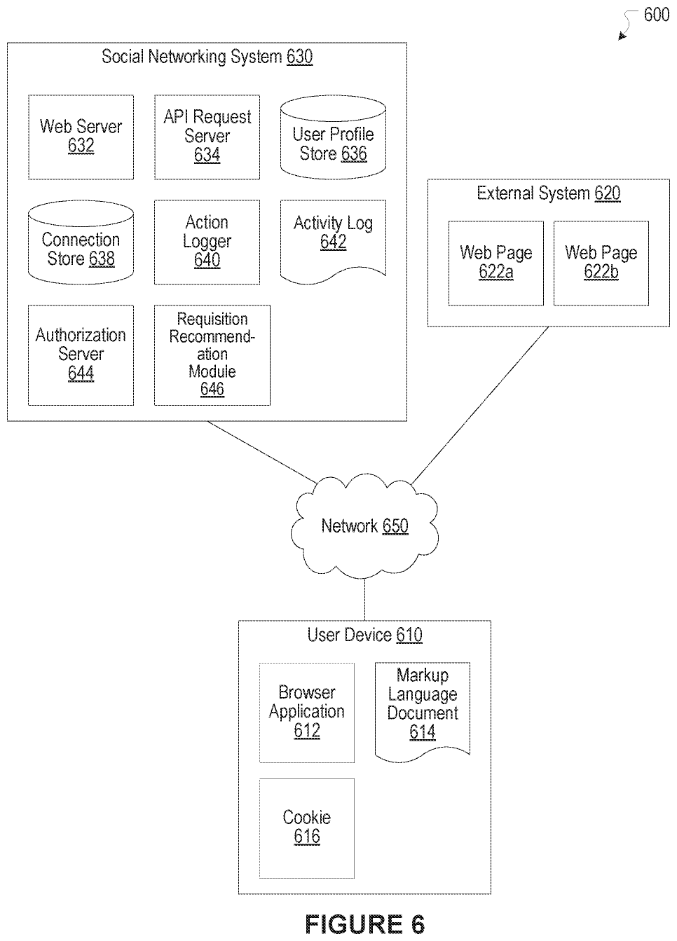

In some embodiments, the requisition recommendation module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some embodiments, the requisition recommendation module 102 can be, in part or in whole, implemented within or configured to operate in conjunction with or be integrated with a social networking system (or service), such as a social networking system 630 of FIG. 6. Likewise, in some instances, the requisition recommendation module 102 can be, in part or in whole, implemented within or configured to operate in conjunction with or be integrated with a client computing device, such as the user device 610 of FIG. 6. For example, the requisition recommendation module 102 can be implemented as or within a dedicated application (e.g., app), a program, or an applet running on a user computing device or client computing system. The application incorporating or implementing instructions for performing functionality of the requisition recommendation module 102 can be created by a developer. The application can be provided to or maintained in a repository. In some cases, the application can be uploaded or otherwise transmitted over a network (e.g., Internet) to the repository. For example, a computing system (e.g., server) associated with or under control of the developer of the application can provide or transmit the application to the repository. The repository can include, for example, an “app” store in which the application can be maintained for access or download by a user. In response to a command by the user to download the application, the application can be provided or otherwise transmitted over a network from the repository to a computing device associated with the user. For example, a computing system (e.g., server) associated with or under control of an administrator of the repository can cause or permit the application to be transmitted to the computing device of the user so that the user can install and run the application. The developer of the application and the administrator of the repository can be different entities in some cases, but can be the same entity in other cases. It should be understood that many variations are possible.

The requisition recommendation module 102 can be configured to communicate and/or operate with the at least one data store 150, as shown in the example system 100. The at least one data store 150 can be configured to store and maintain various types of data including, for example, candidate embeddings and requisition embeddings. In some implementations, the at least one data store 150 can store information associated with the social networking system (e.g., the social networking system 630 of FIG. 6). The information associated with the social networking system can include data about users, social connections, social interactions, locations, geo-fenced areas, maps, places, events, pages, groups, posts, communications, content, feeds, account settings, privacy settings, a social graph, and various other types of data. In some implementations, the at least one data store 150 can store information associated with users, such as user identifiers, user information, profile information, user specified settings, content produced or posted by users, and various other types of user data.

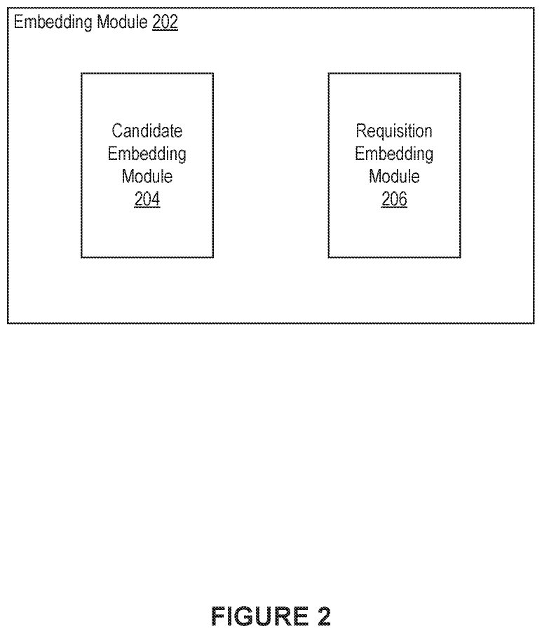

In various embodiments, the embedding module 104 can generate candidate embeddings for candidates and requisition embeddings for requisitions. A candidate embedding for a candidate can be generated based on candidate features associated with the candidate. The candidate embedding can be a numerical (or vector-based) representation of the candidate features. A requisition embedding can be generated based on candidate features of candidates associated with a requisition. The requisition embedding can be a numerical (or vector-based) representation of candidate features that describe a qualified candidate for the requisition. More details regarding the embedding module 104 will be provided with reference to FIG. 2.

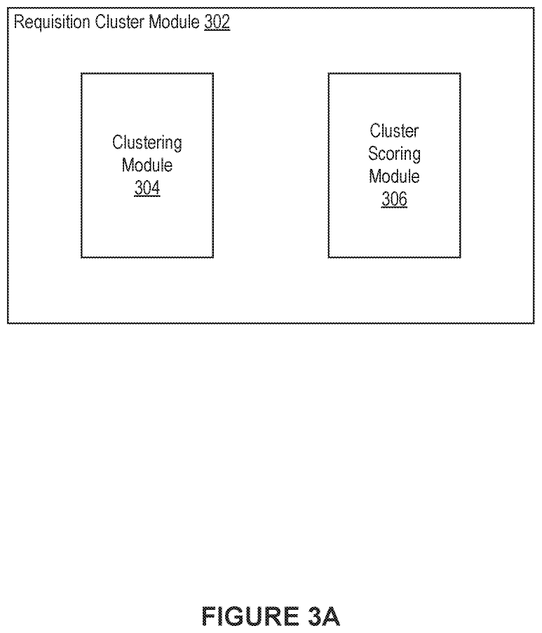

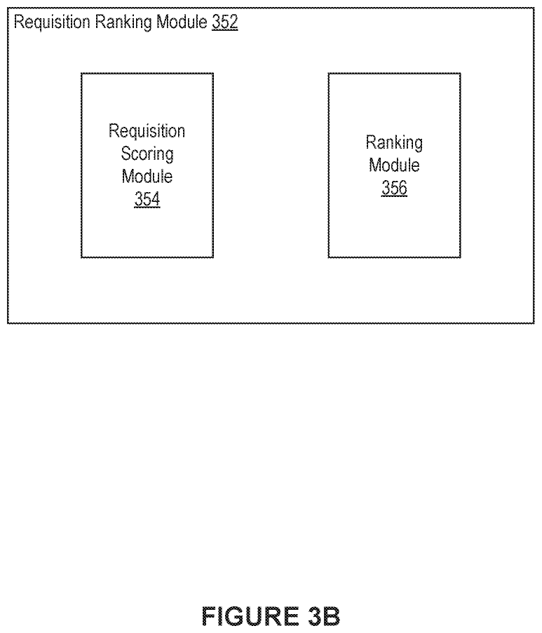

In various embodiments, the requisition cluster module 106 can generate requisition clusters and determine requisition cluster scores for the requisition clusters. A requisition cluster can be generated based on requisition embeddings. Requisition embeddings can be mapped to a vector space, and requisition embeddings that are within a threshold proximity to each other can be grouped into a requisition cluster. Requisitions corresponding to requisition embeddings in a requisition cluster can be similar to each other in that candidates who are qualified for the requisitions can have similar candidate features. The requisition module 106 can also determine requisition cluster scores for the requisition clusters based on a candidate embedding. The requisition cluster scores can indicate affinities between the requisition clusters and the candidate embedding. A requisition cluster with a higher requisition cluster score can be more likely to include requisition embeddings corresponding to requisitions for which a candidate is likely to be qualified than a requisition cluster with a lower requisition cluster score. Accordingly, requisition clusters can be ranked based on their requisition cluster scores. In some embodiments, the requisition cluster module 106 can be one of multiple stages in a multi-stage machine learning methodology. More details regarding the requisition cluster module 106 will be provided with reference to FIG. 3A.

In various embodiments, the requisition ranking module 108 can generate a requisition score based on a requisition embedding of a requisition and a candidate embedding of a candidate. The requisition score can indicate an affinity between the requisition and the candidate. The requisition score can be generated based on a machine learning model. The machine learning model can be trained based on a training set or examples of requisition embeddings of requisitions and candidate embeddings of candidates. The trained machine learning model can be applied to an input requisition embedding and an input candidate embedding and generate a requisition score based on the input requisition embedding and the input candidate embedding. In some embodiments, the requisition ranking module 108 can generate a requisition score for each requisition embedding in a requisition cluster based on a candidate embedding. Requisition embeddings with higher requisition scores are more likely to correspond with requisitions for which the candidate is qualified than requisition embeddings with lower requisition scores. Accordingly, requisition embeddings in a requisition cluster can be ranked based on their requisition scores. In some embodiments, the requisition ranking module 108 can be one of multiple stages in a multi-stage machine learning methodology. More details regarding the requisition ranking module 108 will be provided with reference to FIG. 3B.

FIG. 2 illustrates an example of an embedding module 202 configured to generate candidate embeddings for candidates and requisition embeddings for requisitions. In some embodiments, the embedding module 104 of FIG. 1 can be implemented as the embedding module 202. As shown in FIG. 2, the embedding module 202 can include a candidate embedding module 204 and a requisition embedding module 206.

The candidate embedding module 204 can generate candidate embeddings for candidates in a vector (or embedding) space based on various candidate features associated with the candidates. Candidate features can be based on information related to educational histories and professional experiences of candidates such as skills, certifications, education, prior experiences, prior job titles, and prior projects. Such information can be obtained through, for example, a resume, a form, or an online data source, such as a professional networking website or social networking system. The candidate embedding module 204 can generate candidate embeddings based on various machine learning methodologies. The candidate embedding module 204 can train a machine learning model and apply the machine learning model to generate candidate embeddings for candidates. The machine learning model can be trained with a training set of data including candidate features so that candidates that are relatively similar have associated embeddings that are relatively closer in the vector space and candidates that are relatively dissimilar have associated embeddings that are relatively farther. For example, the machine learning model can be trained based on candidate features of past candidates. The trained machine learning model can be applied to, for example, a resume of a potential candidate and generate a candidate embedding for the potential candidate. In general, candidate embeddings can be numerical representations (e.g., vectors) of candidate features associated with candidates. The candidate embeddings can be mapped to a vector space and compared with other candidate embeddings to determine various interrelationships among the candidate embeddings and the respective candidates. Candidates with candidate embeddings that are closer in proximity may have more similar features than candidates with candidate embeddings that are farther in proximity. Many variations are possible.

The requisition embedding module 206 can generate requisition embeddings for requisitions based on various candidate features of candidates associated with the requisitions. Candidates associated with the requisitions can include candidates that are considered (e.g., contacted, interviewed, hired, etc.) or qualified for the requisitions as well as candidates that are not considered or unqualified for the requisitions. The requisition embedding module 206 can generate requisition embeddings for requisitions based on various machine learning methodologies. The requisition embedding module 206 can train a machine learning model and apply the machine learning model to generate requisition embeddings for requisitions. The machine learning model can be trained with a training set of requisitions and candidate features of candidates associated with the requisitions. Candidate features of candidates considered for requisitions in the training set can be utilized as positive training data. Candidate features of candidates not considered or rejected for requisitions in the training set can be utilized as negative training data. Candidate features of candidates considered for multiple requisitions in the training set can be utilized to identify similar requisitions in the training set. Candidate features of candidates considered for one requisition but not another in the training set can be utilized to identify dissimilar requisitions in the training set. For example, a past candidate may have been interviewed for a number of past requisitions. Candidate features associated with the past candidate can be utilized as positive candidate features associated with the past requisitions. Additionally, the past requisitions can be determined to be similar based on the past candidate being interviewed for them. A trained machine learning model can be applied to a requisition and generate a requisition embedding for the requisition. The trained machine learning model can be applied to, for example, a recently published requisition and generate a requisition embedding for the recently published requisition. In some embodiments, a requisition embedding can be generated for a requisition based on a word comparison or a string comparison between the requisition and requisitions for which requisition embeddings have been generated. In general, requisition embeddings can be numerical representations (e.g., vectors) of their corresponding requisitions. The requisition embeddings can be mapped to a vector space and compared with other requisition embeddings to determine various interrelationships among the requisition embeddings and their corresponding requisitions. Requisitions with requisition embeddings that are closer in proximity are more similar to each other than requisitions with requisition embeddings that are farther in proximity. Many variations are possible.

FIG. 3A illustrates an example of a requisition cluster module 302 configured to generate requisition clusters and to determine requisition cluster scores for the requisition clusters. In some embodiments, the requisition cluster module 302 can be one of multiple stages in a multi-stage methodology for providing requisition recommendations. In some embodiments, the requisition cluster module 106 of FIG. 1 can be implemented as the requisition cluster module 302. As shown in FIG. 3A, the requisition cluster module 302 can include a clustering module 304 and a cluster scoring module 306.

The clustering module 304 can generate requisition clusters based on requisition embeddings of requisitions. Requisition embeddings can be generated from requisitions, for example, by the requisition embedding module 206, as described above. The clustering module 304 can map the requisition embeddings to a vector space and group the requisition embeddings based on their proximity to each other. The requisition embeddings can be grouped using, for example, a nearest neighbor algorithm. Requisition embeddings that are within a threshold proximity to each other can be grouped into a requisition cluster. Requisitions corresponding to requisition embeddings in the requisition cluster can be requisitions for which similar candidates are qualified. For example, a requisition cluster can contain requisition embeddings corresponding to requisitions that prioritize a certain skill. Accordingly, a potential candidate with the certain skill may be qualified for one or more of the requisitions corresponding to requisition embeddings in the requisition cluster. Requisitions from which requisition embeddings are generated can include past requisitions as well as current requisitions. Generating requisition clusters based on requisition embeddings for past requisitions and current requisitions can increase the number of requisition embeddings in a requisition cluster. For example, an organization may currently have ten requisitions for currently available job positions. Requisition embeddings can be generated for the ten requisitions and requisitions for past, previously filled positions. Accordingly, requisition clusters can be generated based on the requisition embeddings and the generated requisition clusters can contain more requisition embeddings than they would if only ten requisition embeddings were generated.

The cluster scoring module 306 can determine requisition cluster scores for requisition clusters based on a candidate embedding for a candidate. A requisition cluster score can be associated with a likelihood that a requisition cluster contains requisition embeddings corresponding to requisitions for which a candidate is qualified. The cluster scoring module 306 can determine requisition cluster scores based on various machine learning methodologies. The cluster scoring module 306 can train a machine learning model and apply the machine learning model to determine requisition cluster scores for requisition clusters. The machine learning model can be trained with a training set or examples of requisition clusters and candidate embeddings. A requisition cluster in the training set that contains at least one requisition embedding corresponding to a requisition for which a candidate is considered (e.g., contacted, interviewed, hired, etc.) can be utilized as positive training data. A requisition cluster in the training set that does not contain any requisition embeddings corresponding to requisitions for which the candidate is considered can be utilized as negative training data. For example, a past candidate may have been considered for a number of past requisitions. A candidate embedding for the past candidate and requisition clusters that include requisition embeddings corresponding to the past requisitions for which the past candidate was considered can be utilized as positive training data. Requisition clusters that do not include requisition embeddings corresponding to the past requisitions for which the past candidate was considered can be utilized as negative training data. A trained machine learning model can be applied to a set of requisition clusters and a candidate embedding to determine requisition cluster scores for each requisition cluster in the set of requisition clusters. The requisition cluster scores can be associated with a likelihood that a requisition cluster in the set of requisition clusters includes a requisition embedding corresponding to a requisition for which a candidate corresponding to the candidate embedding is qualified. Requisition clusters with higher requisition cluster scores can be more likely to include a requisition embedding corresponding to a requisition for which a candidate is qualified than requisition clusters with lower requisition cluster score. The cluster scoring module 306 can rank the requisition clusters based on their requisition cluster scores. The highest ranking requisition clusters can be associated with requisition clusters most likely to include requisition embeddings corresponding to requisitions for which a candidate is likely to be qualified. For example, an organization may have a large volume of requisitions for a large number of available positions. The available positions may be varied and prioritize different skills. Requisition clusters can be generated for requisition embeddings of the large volume of requisitions. Requisition cluster scores can be determined for the requisition clusters based on a candidate embedding for a potential candidate. The requisition clusters can be ranked based on the requisition cluster scores. The highest ranking requisition clusters (e.g., top three requisition clusters) can include requisition embeddings corresponding to requisitions that prioritize skills that the potential candidate has. The lowest ranking requisition clusters can include requisition embeddings corresponding to requisitions that prioritize skills that the potential candidate does not have. Many variations are possible.

FIG. 3B illustrates an example of a requisition ranking module 352 configured to determine requisition scores based on requisition embeddings and candidate embeddings and to rank requisitions based on the requisition scores. In some embodiments, the requisition ranking module 352 can be one of multiple stages in a multi-stage methodology for providing requisition recommendations. In some embodiments, the requisition ranking module 108 of FIG. 1 can be implemented as the requisition ranking module 352. As shown in FIG. 3B, the requisition ranking module 352 can include a requisition scoring module 354 and a ranking module 356.

The requisition scoring module 354 can determine requisition scores for requisition embeddings based on a candidate embedding. The requisition scoring module 354 can determine requisition scores based on various machine learning methodologies. The requisition scoring module 354 can train a machine learning model and apply the machine learning model to determine requisition scores. The machine learning model can be trained with a training set or examples of requisition embeddings and candidate embeddings. Candidate embeddings corresponding to candidates that were considered for requisitions and requisition embeddings corresponding to the requisitions can be utilized as positive training data. Candidate embeddings corresponding to candidates that were not considered for requisitions and requisition embeddings corresponding to the requisitions can be utilized as negative training data. For example, candidate embeddings corresponding to candidates that were considered for a past requisition and a requisition embedding corresponding to the past requisition can be utilized together as a set or examples of positive training data. Candidate embeddings corresponding to candidates that were not considered for the past requisition can be utilized along with the requisition embedding as a set or examples of negative training data. In some embodiments, requisitions can have more candidates that were not considered than candidates that were considered and, accordingly, negative training data based on the requisitions and the candidates that were not considered can be sampled. A trained machine learning model can be applied to requisition embeddings and a candidate embedding to determine requisition scores for the requisition embeddings. The requisition scores can indicate an affinity between requisitions corresponding to the requisition embeddings and a candidate corresponding to the candidate embedding. Requisition embeddings with higher requisition scores can correspond to requisitions for which a candidate is more likely to be qualified than requisition embeddings with lower requisition scores.

The ranking module 356 can rank requisitions based on requisition scores of requisition embeddings corresponding to the requisitions. In some embodiments, the ranking module 356 can rank requisitions corresponding to requisition embeddings in a requisition cluster. For example, an organization may have a large volume of requisitions for a large number of available positions. Requisition embeddings corresponding to the requisitions can be grouped into requisition clusters and the highest ranking requisition clusters can be determined based on a candidate embedding corresponding to a potential candidate. The requisition ranking module 356 can rank the requisition embeddings in the highest ranking requisition clusters and, based on the ranking, determine requisitions for which the potential candidate is likely to be qualified. In this example, ranking requisition embeddings in the highest ranking requisition clusters may be more efficient and accurate than ranking requisition embeddings of all the requisitions. The ranking module 356 can rank requisitions based on factors in addition to requisition scores. In some embodiments, the ranking module 356 can exclude fulfilled requisitions from being ranked. In some embodiments, requisitions that have been inactive for a threshold period of time can be excluded from being ranked. Requisitions may become inactive, for example, because they are fulfilled, replaced with newer requisitions, or associated with positions that are not needed. For example, a requisition for which no candidates have been considered for 30 days can be excluded from being ranked. In some embodiments, the ranking module 356 can weight requisition scores based on geographical location. A requisition score can be weighted based on a geographical distance between a geographical location associated with a requisition and a geographical location associated with a candidate. For example, a potential candidate may be located in Boston, Mass., and a requisition may be for an available position in San Francisco, Calif. It may be unlikely for the potential candidate to want to move from Boston to San Francisco. Accordingly, a requisition score based on a requisition embedding corresponding to the requisition and a candidate embedding corresponding to the potential candidate can be decreased based on the geographical distance between Boston and San Francisco. Many variations are possible.

The ranking module 356 can recommend requisitions based on requisition scores. A requisition associated with a higher requisition score is more likely to be a requisition for which a candidate is qualified than a requisition associated with a lower requisition score. Accordingly, the ranking module 356 can rank requisitions based on their associated requisition score. The highest ranking requisitions can be provided as recommended requisitions for a candidate. In some embodiments, the ranking module 356 can recommend requisitions associated with requisition scores exceeding a threshold score. For example, an organization may have a large volume of requisitions for a large number of available positions. The organization may receive interest from potential candidates and hire a number of recruiters to approach qualified candidates. For each potential candidate, the ranking module 356 can determine the highest ranking requisitions and provide these requisitions to the recruiters as recommendations. Many variations are possible.

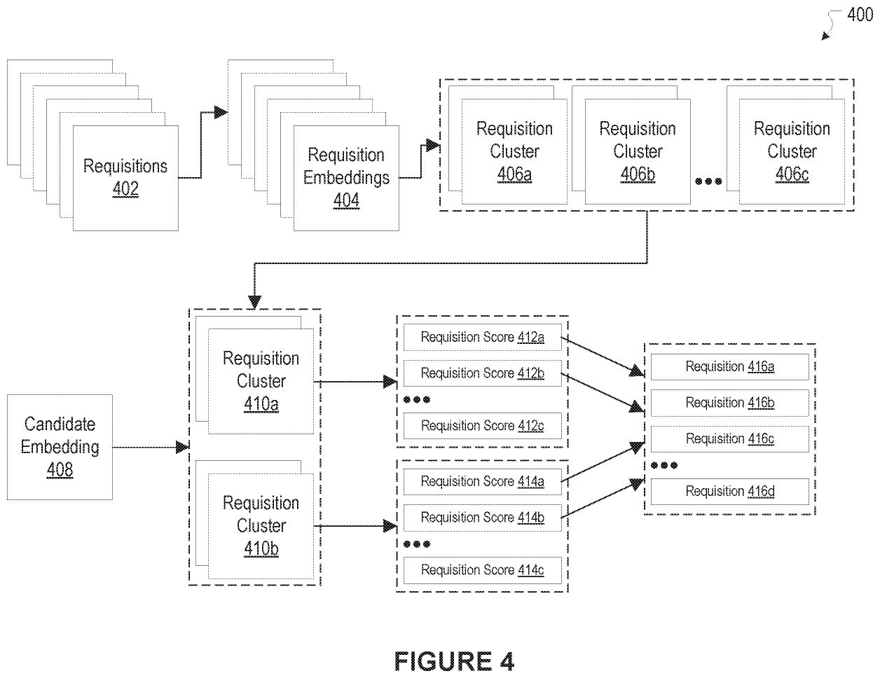

FIG. 4 illustrates an example functional block diagram 400, according to an embodiment of the present technology. The example functional block diagram 400 illustrates an example multi-stage methodology for ranking requisitions, as can be performed by the requisition recommendation module 102. It should be understood that there can be additional, fewer, or alternative steps performed in similar or alternative orders, or in parallel, based on the various features and embodiments discussed herein unless otherwise stated.

In this example, requisition embeddings 404 can be generated from requisitions 402. The requisition embeddings 404 can be generated, for example, by the requisition embedding module 206 of FIG. 2. The requisition embeddings 404 can be grouped into a set of requisition clusters including requisition clusters 406a, 406b, 406c. The requisition embeddings 404 can be grouped into the set of requisition clusters, for example, by the clustering module 304 of FIG. 3A. A subset of requisition clusters, including requisition clusters 410a, 410b, can be selected from the set of requisition clusters based on a candidate embedding 408. The subset of requisition clusters can be selected based on requisition cluster scores determined, for example, by the cluster scoring module 306 of FIG. 3A. Requisition clusters 410a, 410b can include requisition embeddings corresponding to requisitions for which a candidate corresponding to candidate embedding 408 is likely to be qualified. A first set of requisition scores, including requisition scores 412a, 412b, 412c, can be generated for requisitions in requisition cluster 410a. Similarly, a second set of requisition scores, including requisition scores 414a, 414b, 414c, can be generated for requisitions in requisition cluster 410b. The first set of requisition scores and the second set of requisition scores can be generated, for example, by the requisition scoring module 354 of FIG. 3B. The first set of requisition scores and the second set of requisition scores can be ranked, for example, by the ranking module 356 of FIG. 3B. A set of requisitions, including requisitions 416a, 416b, 416c, 416d, can be selected from requisitions 402 based on the ranking of the first set of requisition scores and the second set of requisition scores. The set of requisitions can correspond with requisitions associated with the highest requisition scores. The set of requisitions can be provided as recommended requisitions, for example, to a recruiter. All examples herein are provided for illustrative purposes, and there can be many variations and other possibilities.

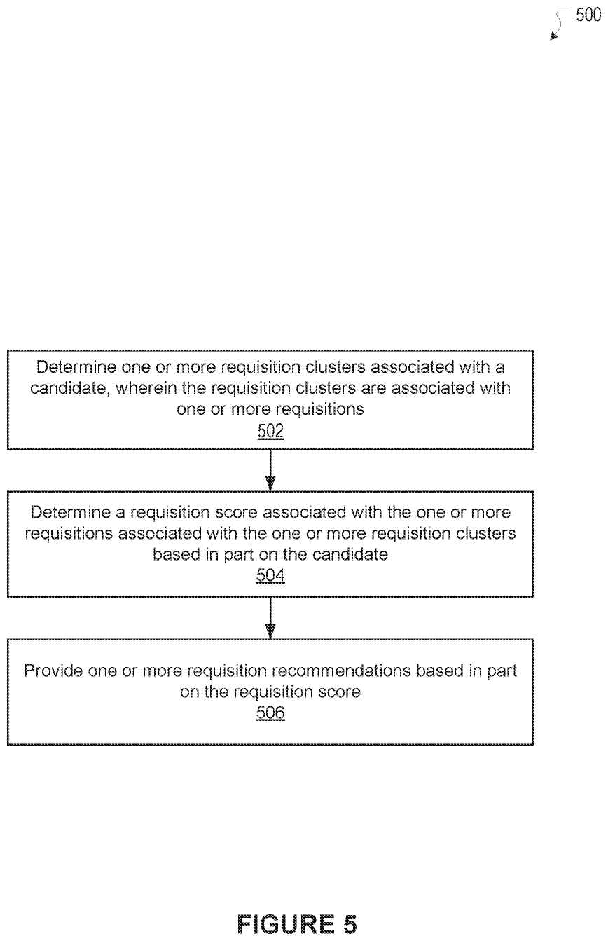

FIG. 5 illustrates an example method 500 for generating a set of requisition recommendations, according to an embodiment of the present technology. It should be understood that there can be additional, fewer, or alternative steps performed in similar or alternative orders, or in parallel, based on the various features and embodiments discussed herein unless otherwise stated.

At block 502, the example method 500 can determine one or more requisition clusters associated with a candidate, wherein the requisition clusters are associated with one or more requisitions. The requisition clusters can be determined based on their requisition cluster scores, as described herein. At block 504, the example method 500 can determine a requisition score associated with the one or more requisitions associated with the one or more requisition clusters based in part on the candidate. At block 506, the example method 500 can provide one or more requisition recommendations based in part on the requisition score. All examples herein are provided for illustrative purposes, and there can be many variations and other possibilities.

It is contemplated that there can be many other uses, applications, and/or variations associated with the various embodiments of the present technology. For example, in some cases, user can choose whether or not to opt-in to utilize the present technology. The present technology can also ensure that various privacy settings and preferences are maintained and can prevent private information from being divulged. In another example, various embodiments of the present technology can learn, improve, and/or be refined over time.

### Social Networking System—Example Implementation

FIG. 6 illustrates a network diagram of an example system 600 that can be utilized in various scenarios, in accordance with an embodiment of the present technology. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices (or systems) that can receive input from a user and transmit and receive data via the network 650. In one embodiment, the user device 610 is a computer system executing, for example, a Microsoft Windows compatible operating system (OS), macOS, and/or a Linux distribution. In another embodiment, the user device 610 can be a computing device or a device having computer functionality, such as a smart-phone, a tablet, a personal digital assistant (PDA), a mobile telephone, a laptop computer, a wearable device (e.g., a pair of glasses, a watch, a bracelet, etc.), a camera, an appliance, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the Silverlight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content. As discussed previously, it should be appreciated that there can be many variations or other possibilities.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects another user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music, or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list.” External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a requisition recommendation module 646. The requisition recommendation module 646, for example, can be implemented as some or all of the functionality of the requisition recommendation module 102 of FIG. 1. In some embodiments, some or all of the functionality of the requisition recommendation module 646 can be implemented in the user device 610. As discussed previously, it should be appreciated that there can be many variations or other possibilities.

### Hardware Implementation

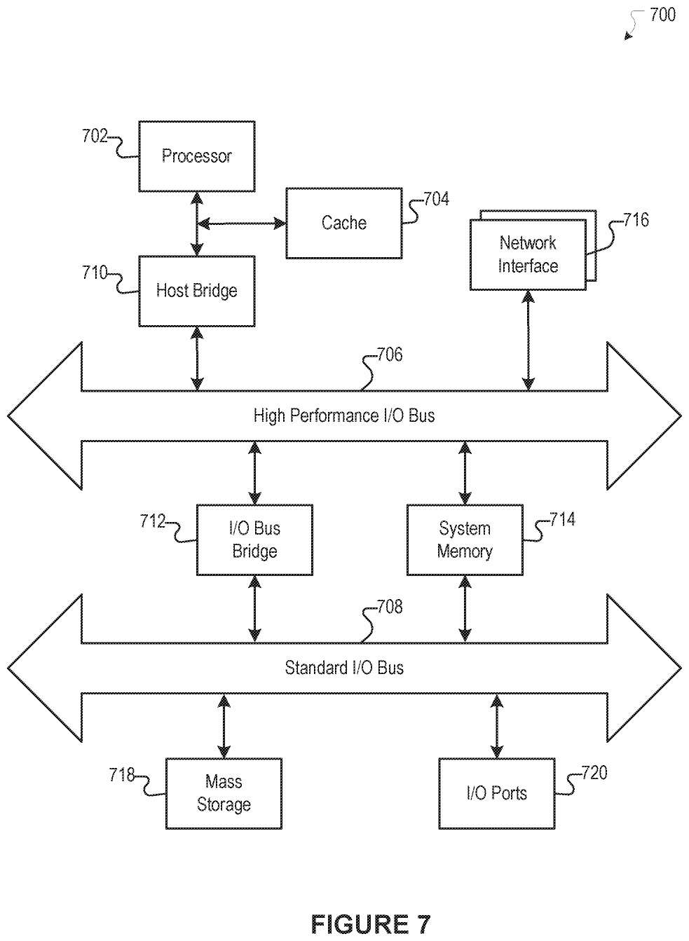

The foregoing processes and features can be implemented by a wide variety of machine and computer system architectures and in a wide variety of network and computing environments. FIG. 7 illustrates an example of a computer system 700 that may be used to implement one or more of the embodiments described herein in accordance with an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 720, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module,” with processor 702 being referred to as the “processor core.” Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs.” For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the technology can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment,” “an embodiment,” “other embodiments,” “one series of embodiments,” “some embodiments,” “various embodiments,” or the like means that a particular feature, design, structure, or characteristic described in connection with the embodiment is included in at least one embodiment of the technology. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the embodiments of the invention are intended to be illustrative, but not limiting, of the scope of the invention, which is set forth in the following claims.

1. A computer-implemented method comprising:
generating, by a computing system, requisition embeddings for requisitions based on candidate features of candidates associated with the requisitions, wherein the generating comprises:
training, by the computing system, a first machine learning model based on first training data that includes first example candidate features of first example candidates for a first example requisition, wherein a positive training instance in the first training data includes the first example candidate features of the first example candidates considered for the first example requisition and a negative training instance in the first training data includes the first example candidate features of the example candidates rejected for the first example requisition;
generating, by the computing system, requisition clusters of the requisitions based on the requisition embeddings;
determining, by the computing system, requisition cluster scores for the requisition clusters based on a candidate embedding for a candidate, wherein the requisition cluster scores indicate a likelihood that a requisition cluster of the requisition clusters includes a requisition for which the candidate is qualified, and wherein the determining the requisition cluster scores comprises:
training, by the computing system, a second machine learning model based on second training data that includes at least a first example requisition cluster that contains at least one example requisition for which an example candidate was considered and a second example requisition cluster that contains no requisitions for which the example candidate was considered;
determining, by the computing system, at least one requisition cluster of the requisition clusters for the candidate based on the requisition cluster scores of the requisition clusters, wherein the at least one requisition cluster includes at least one past requisition and at least one current requisition for which the candidate is qualified;
determining, by the computing system, requisition scores for the requisitions of the at least one requisition cluster based on the candidate embedding; and
providing, by the computing system, one or more requisition recommendations for the candidate based on the requisition scores.

2. The computer-implemented method of claim 1, further comprising:
mapping, by the computing system, the requisitions to a space, wherein the generating the requisition clusters is based on the requisition embeddings that are within a threshold proximity to each other in the space.

3. The computer-implemented method of claim 1, further comprising:
training, by the computing system, a third machine learning model to generate candidate embeddings for candidates based on candidate features associated with the candidates.

4. The computer-implemented method of claim 1, wherein determining the at least one requisition cluster of the requisition clusters comprises:
determining the requisition cluster scores for the requisition clusters based on the candidate embedding; and
ranking the requisition clusters based on the requisition cluster scores.

5. The computer-implemented method of claim 1, wherein each requisition cluster is associated with a respective prioritized skill, and wherein the requisition clusters are ranked based on the requisition clusters that include requisitions that prioritize skills that the candidate has.

6. The computer-implemented method of claim 1, wherein the requisition scores are weighted based on geographical distances between geographical locations of the requisitions and a geographical location of the first candidate.

7. The computer-implemented method of claim 1, wherein providing the one or more requisition recommendations comprises:
ranking the requisitions of the at least one requisition cluster based on the requisition scores.

8. The computer-implemented method of claim 7, wherein requisitions that have been inactive for a threshold period of time are excluded from the ranking.

9. The computer-implemented method of claim 7, wherein requisitions that have been fulfilled are excluded from the ranking.

10. The computer-implemented method of claim 1, wherein the candidate features include educational histories and professional experiences of the candidates.

11. A system comprising:
at least one processor; and
a memory storing instructions that, when executed by the at least one processor, cause the system to perform operations comprising:
generating requisition embeddings for requisitions based on candidate features of candidates associated with the requisitions, wherein the generating comprises:
training a first machine learning model based on first training data that includes first example candidate features of first example candidates for a first example requisition, wherein a positive training instance in the first training data includes the first example candidate features of the first example candidates considered for the first example requisition and a negative training instance in the first training data includes the first example candidate features of the example candidates rejected for the first example requisition;
generating requisition clusters of the requisitions based on the requisition embeddings;
determining requisition cluster scores for the requisition clusters based on a candidate embedding for a candidate, wherein the requisition cluster scores indicate a likelihood that a requisition cluster of the requisition clusters includes a requisition for which the candidate is qualified, and wherein the determining the requisition cluster scores comprises:
training a second machine learning model based on second training data that includes at least a first example requisition cluster that contains at least one example requisition for which an example candidate was considered and a second example requisition cluster that contains no requisitions for which the example candidate was considered;
determining at least one requisition cluster of the requisition clusters for the candidate based on the requisition cluster scores of the requisition clusters, wherein the at least one requisition cluster includes at least one past requisition and at least one current requisition for which the candidate is qualified;
determining requisition scores for the requisitions of the at least one requisition cluster based on the candidate embedding; and
providing one or more requisition recommendations for the candidate based on the requisition scores.

12. The system of claim 11, the operations further comprising:
mapping the requisitions to a space, wherein the generating the requisition clusters is based on the requisition embeddings that are within a threshold proximity to each other in the space.

13. The system of claim 11, the operations further comprising:
training a third machine learning model to generate candidate embeddings for candidates based on candidate features associated with the candidates.

14. The system of claim 11, wherein determining the at least one requisition cluster of the requisition clusters comprises:
determining the requisition cluster scores for the requisition clusters based on the candidate embedding; and
ranking the requisition clusters based on the requisition cluster scores.

15. The system of claim 11, each requisition cluster is associated with a respective prioritized skill, and wherein the requisition clusters are ranked based on the requisition clusters that include requisitions that prioritize skills that the candidate has.

16. A non-transitory computer-readable storage medium including instructions that, when executed by at least on processor of a computing system, cause the computing system to perform operations comprising:
generating requisition embeddings for requisitions based on candidate features of candidates associated with the requisitions, wherein the generating comprises:
training a first machine learning model based on first training data that includes first example candidate features of first example candidates for a first example requisition, wherein a positive training instance in the first training data includes the first example candidate features of the first example candidates considered for the first example requisition and a negative training instance in the first training data includes the first example candidate features of the example candidates rejected for the first example requisition;
generating requisition clusters of the requisitions based on the requisition embeddings;
determining requisition cluster scores for the requisition clusters based on a candidate embedding for a candidate, wherein the requisition cluster scores indicate a likelihood that a requisition cluster of the requisition clusters includes a requisition for which the candidate is qualified, and wherein the determining the requisition cluster scores comprises:
training a second machine learning model based on second training data that includes at least a first example requisition cluster that contains at least one example requisition for which an example candidate was considered and a second example requisition cluster that contains no requisitions for which the example candidate was considered;
determining at least one requisition cluster of the requisition clusters for the candidate based on the requisition cluster scores for of the requisition clusters, wherein the at least one requisition cluster includes at least one past requisition and at least one current requisition for which the candidate is qualified;
determining requisition scores for the requisitions of the at least one requisition cluster based on the candidate embedding; and
providing one or more requisition recommendations for the candidate based on the requisition scores.

17. The non-transitory computer-readable storage medium of claim 16, the operations further comprising:
mapping the requisitions to a space, wherein the generating the requisition clusters is based on the requisition embeddings that are within a threshold proximity to each other in the space.

18. The non-transitory computer-readable storage medium of claim 16, the operations further comprising:
training a third machine learning model to generate candidate embeddings for candidates based on candidate features associated with the candidates.

19. The non-transitory computer-readable storage medium of claim 16, wherein determining the at least one requisition cluster of the requisition clusters comprises:
determining the requisition cluster scores for the requisition clusters based on the candidate embedding; and
ranking the requisition clusters based on the requisition cluster scores.

20. The non-transitory computer-readable storage medium of claim 16, wherein each requisition cluster is associated with a respective prioritized skill, and wherein the requisition clusters are ranked based on the requisition clusters that include requisitions that prioritize skills that the candidate has.
